(19) United States
(12) Patent Application Publication
(10) Pub. No.: US 2005/0195510 A1
(43) Pub. Date: Sep. 8, 2005

(54) Feedback-controlled optical servo writer

(75) Inventors: Daniel R. Skaar, Denver, CO (US); Hong Chen, Worcester, MA (US)

Correspondence Address: MORRISON & FOERSTER LLP, 425 MARKET STREET, SAN FRANCISCO, CA, 94105-2482, US

(73) Assignee: Quantum Corporation, San Jose, CA (US)

(21) Appl. No.: 10/794,697

(22) Filed: Mar. 4, 2004

(51) Int. Cl. G11B 27/36; G11B 5/584; G11B 5/09

(52) U.S. Cl. 360/31; 360/77.12; 360/48

(57) ABSTRACT

A system for calibrating servo marks formed in a tape medium includes an emitter for directing a beam of radiation toward the medium to form one or more servo marks. A detector detects the images of the marks, and determines one or more parameters of the marks. The controller adjusts power of the radiation beam based on the parameters.

### BACKGROUND OF THE INVENTION

1. Field of the Invention

The present invention relates to tracking movement of a magnetic tape, and more specifically to forming optical servo tracks on the tape.

2. Related Art

Mass storage devices and media require increased data storage capacity and retrieval performance. As to linear tape recording, in particular, a popular trend is toward multi-head, multi-channel fixed head structures with narrowed recording gaps and track widths, so that many linear tracks may be achieved on a tape medium of predetermined width. Tape substrates are also being made thinner, with increased tape lengths being made possible in small diameter reel packages.

Because of relatively high linear tape velocity, and because tape substrates continue to be made progressively thinner, guiding tape past a tape head structure along an accurate invariant linear path has proven to be difficult. One tracking error phenomenon is known as lateral tape motion (“LTM”). An optical servo controller may be employed to track lateral motion of the tape relative to a recording head, as described in U.S. Pat. No. 6,246,535, to Saliba, et al., entitled “Optical Apparatus for Tracking a Magnetic Tape,” incorporated by reference herein in its entirety. To this end, the tape may include an optically detectable servo track that can be placed on the non-magnetic side of the tape, for example. An optical pickup head detects light reflected from the servo track. In response, the optical servo controller controls lateral head position to reduce the effects of LTM. By tracking lateral tape motion, this technique allows for narrower track width and thus greater storage density on the tape.

Typical coated magnetic media technology includes front and back coated layers comprising polymer binder systems with pigments or fillers, which may or may not be magnetic in nature based on each layer's function. Additionally, other additives may be formulated into the coating layers to control wear and friction. The dispersion of these components affect the uniformity of the formulation. The coating thickness uniformity and the formulation homogeneity directly affects the amount of the energy absorbed by a layer from a given laser pulse. Thus, any variations in layer consistency result in changes in energy absorption and non-uniform ablation of the desired servo mark.

In conventional optical servo writing systems, the servo tracks are written in an open loop manner. After calibration, the servo writer may monitor optical power to account for power supply drift. This conventional feedback technique nevertheless does not correct for variations in servo track writing caused by layer inconsistencies in different batches of tape media.

### SUMMARY OF THE INVENTION

A system for calibrating servo marks formed in a tape medium includes an emitter for directing a beam of radiation toward the medium to form one or more servo marks. A detector detects one or more images of the marks, and determines one or more parameters of the marks from the image(s). The controller adjusts power of the radiation beam based on the parameter(s). The emitter may be a laser, and the detector may include at least one CCD array. The parameters may include diameter and depth.

The tape medium may include at least two layers, where the emitter forms at least one mark in a layer opposite a magnetic surface of the medium.

Each image detected by the detector may represent multiple marks along a servo track in a longitudinal direction. More broadly, each image detected by the detector may represent an area of marks from multiple servo tracks in both the longitudinal and lateral directions.

The detector may provide to the controller the image(s) of the marks. The controller may then compare the images to a reference image, and determine the parameter(s) based on the comparison. Each image provided by the detector may represent multiple marks along a servo track in a longitudinal direction, or an area of marks from multiple servo tracks in both longitudinal and lateral directions.

The detector may include two imaging elements that provide images to the controller. The controller may stereoscopically determine the parameters based on the images from the imaging elements.

Based on the foregoing principles a tape medium may be formed comprising multiple layers, including a magnetic layer for storing information. Multiple servo marks may be disposed in at least one layer in a longitudinal direction on the medium. The servo marks may have a spatial density of at least 10,000, or more preferably, 14,000 marks per meter in the. longitudinal direction. The servo marks may also be disposed in a lateral direction on the medium, with the servo marks having a spatial density of at least 10,000, or more preferably, 14,000 marks per meter in the lateral direction. Each servo mark may be within approximately 2-12 microns in diameter and 20-200 nm in depth.

Due to the accuracy provided by the system of the invention, multiple tape media having servo tracks may be formed, where the servo mark parameters are maintained within close tolerances across the media. The first and second tapes may be produced from different tape batches. A first tape medium has a first set of servo marks; and a second tape medium has a second set of servo marks. Each tape medium includes multiple layers including a track layer. The first and second sets of servo marks may be written in the track layer by the same servo writer. The track layer of the first tape medium may differ in thickness from the track layer of the second tape medium, with the first set of servo marks having substantially the same diameter as the second set of servo marks. The first set of servo marks may also have substantially the same depth as the second set of servo marks.

For example, the thickness of the track layer of the first tape medium may be within 12% of the thickness of the track layer of the second tape medium, with the diameter of each mark of the first set of servo marks being within 1.0% of the diameter of each mark of the second set of servo marks, and the depth of each mark of the first set of servo marks being within 15.0% of the depth of each mark of the second set of servo marks. The servo marks may have a spatial density of at least 10,000, or more preferably, 14,000 servo marks per meter in the longitudinal and lateral directions.

### BRIEF DESCRIPTION OF THE DRAWINGS

FIG. 1 illustrates an optical servo writer according to an embodiment of the present invention.

FIG. 2 illustrates a hole formed by an optical servo writer according to an embodiment of the present invention.

### DETAILED DESCRIPTION OF EXEMPLARY EMBODIMENTS

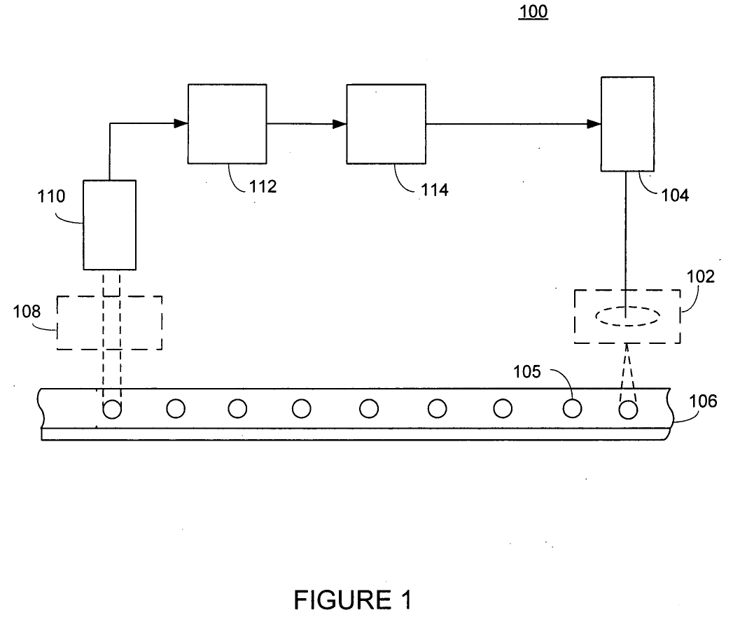

FIG. 1 illustrates an embodiment of an optical servo writer 100 of the present invention. Through imaging optics 102, an emitter 104 such as a laser writes servo marks 105 on a medium 106, such as recording tape. The imaging optics may, for example, include lenses, prisms or diffractive optics. Each mark may be, for example, a hole or depression 2-12 microns (um) or less in diameter and 20-200 nm or less in depth. Alternatively, a mark may comprise other shapes, such as an oblong shape in the longitudinal direction of the tape. An oblong mark or line may be produced by using a laser having a sufficiently long pulse width applied to the medium as the medium moves. Those skilled in the art will recognize that the servo system of the invention may write a wide variety of patterns on the medium.

The laser 104 may, for example, employ pulsed laser ablation to write the marks. The power delivered by the laser may be controlled by varying the laser pulse width and/or the power applied to the laser. The laser output power may, for example, be between 0.5 to 5 watts producing writing energy on the medium of 0.03 to 3.0 ujoules per servo mark, for example. The laser may, for example, operate in the near infrared (approximately 1064 nm) through the near ultraviolet (approximately 355 nm) portion of the spectrum.

The laser 104 may write the marks on an outer surface layer such as the back coat or an intermediate layer of the medium 106. Using a beam expander or a similar component such as diffractive optics, the laser 104 may write more than one mark at a time.

In an optical servo control system, a series of marks, such as substantially circular holes, form the servo tracks. A number of quality parameters (e.g., diameter, depth, roundness, feature sharpness, amount of debris) determine whether a servo mark will be detected by the servo controller, while at the same time avoiding penetration beyond the layer dedicated to holding the servo tracks.

Referring to the embodiment shown in FIG. 1, through magnifying optics 108, a detector 110 captures one or more images of one or more marks that have been written (e.g., simultaneously) by the laser 104. The detector 110 may comprise one or more CCD arrays or other imaging elements. CCD optical resolution is limited by light diffraction limits, characterized by wavelength. For visible light, the resolution is approximately 0.5 to 1.0 microns. By averaging multiple images or using greater magnification, a smaller resolution may be obtained. Each imaging element may, for example, employ a 1 to 6 Mpixel CCD sized to resolve 20-30 nm by averaging multiple images. The CCD detector wavelength may be in the range 350 to 1100 nm, for example.

A controller 112 receives at least one image from the detector 110. Based on the received image(s), the controller 112 measures various quality parameters of the one or more holes, and compares the measured parameters to desired parameters during writing of the marks when calibrating the laser power. The parameters may include, for example, diameter and depth. The quality parameters are directly related to the physical characteristics of the tape layer bearing the servo marks. In particular, the uniformity of the layer relates to the ability of the layer to absorb laser energy uniformly, and thus to the uniformity of the resulting ablated servo mark. The uniformity of the laser beam or beams producing the energy for the ablation process is affected by the quality of the beam optical system and the stability of the laser power system. The optical system is considered fixed. Thus, the servo mark quality is mostly controlled by the energy level selected for a given layer uniformity. The closed loop system of the invention compensates for any drift in the stability of the laser by controlling the beam power level.

Accordingly, based on the comparison of the measured parameters to desired parameters, the controller 112 provides a control signal to control a laser power supply 114. The controller 112 may include a processor and interface circuitry to interface with the power supply 114. The control signal is tailored to control the power of the laser in order to minimize the error between measured and desired hole parameters.

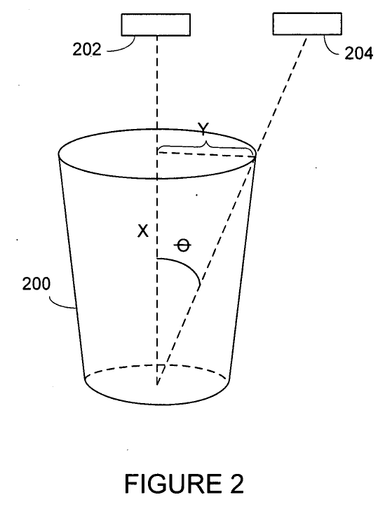

FIG. 2 illustrates imaging of a hole 200. In this example, the hole 200 is modeled as a frustum having a depth x and radius y, and the detector 110 includes a first imaging element 202 and a second imaging element 204, each imaging element located a known distance above the hole. Using known alignment techniques, the first imaging element 202 may be positioned directly over the hole 200, whereas the second imaging element 204 may be positioned to view the hole 200 offset at a predetermined angle θ from the centerline of the hole. The angle may, for example, be 30 degrees. Alternatively, both holes may be positioned at other known angles with respect to the hole. The combination of “viewing” angle and accompanying magnification are used to enhance the particular geometric feature(s) of interest, here dimensions of the servo marks. Using conventional stereoscopic techniques, the processor 112 may use the images received from imaging elements 202, 204 to determine quality parameters, such as the diameter and depth of the hole 200.

The controller 112 determines the extent to which the measured diameter and depth match the desired diameter and depth, and provides a control signal to reduce the error. In response, power supply 114 adjusts the laser power to change the mark size accordingly during the writing of the mark(s).

By employing the feedback-controlled servo writer calibration technique of the invention, the servo writer may, for example, produce a medium, e.g., tape, having servo mark spatial densities of approximately 10,000, or more preferably, at least 14,000 marks per meter in the longitudinal and lateral directions.

Alternatively, the detector 110 may employ only a single imaging element 204. Viewing the hole at a known angle, the imaging element 204 would see the bottom of the hole in two dimensions as a convex shape or roughly as an ellipse. Based on prior empirical measurements, the processor 112 may maintain in memory a “schedule” or lookup table of the relationship between representative hole images and hole quality parameters such as diameter and depth. In response to the image measured by the imaging element 204, the processor 112 determines the hole diameter and depth using the lookup table. Instead of basing this correlation on the entire measured image, the processor may alternatively just extract the length of the major and minor (i.e., maximum and minimum length) axes of the image of the bottom of the hole, and apply those measurements to a corresponding lookup table to obtain quality parameters, such as hole diameter and depth.

The servo writer may control laser power based on the imaging of more than one mark at a time. For example, one or more imaging elements may image multiple marks along the same servo track (i.e., in the longitudinal direction). Each element may image multiple marks by adjusting the magnifying optics to achieve the appropriate field of view. In doing so, each element views each mark at a different angle with respect to the mark.

The multiple marks may be imaged stereoscopically or using the lookup table techniques described above. When employing a lookup table, the controller 112 maintains in the lookup table empirical data of the relationship between representative reference mark images and mark quality parameters (e.g., diameter and depth). Each entry of the lookup table may be associated with a reference image of multiple marks in the longitudinal direction as viewed by the one or more imaging elements from predetermined position(s). The controller 112 uses the lookup table and the detected marks to determine the measured parameters. The controller 112 compares the measured parameters to the desired parameters to thereby determine the error to be minimized.

Similarly, the one or more imaging elements may image multiple marks from both the same servo track and neighboring tracks (i.e., along the longitudinal and lateral axes). In this case, each imaging element may view a number of marks at various angles along both axes. If a lookup table is used, the lookup table may store areal reference images to be compared to the detected images.

In addition to calibrating according to the number of dots viewed per image, the servo writer may take a number of images from different (e.g., contiguous) portions of the medium 106 to complete the calibration of the servo writer. The servo writer of the invention employs feedback control to permit the laser power to be adjusted to account for inconsistencies among different media compositions. For example, surface characteristics of a tape backcoat layer (where servo tracks may be written) may vary from batch to batch. Tape is typically produced in jumbo rolls, each 1 meter wide by 10-20 Km long, for example. The jumbo roll is sliced into batches called “pancakes.” A statistically significant number of sample portions of tape from various segments along the length may be imaged and used to calibrate the servo writer for that pancake. For example, the segments may be a number of contiguous segments taken from the beginning, middle and end of the tape.

Alternatively, considering productivity and efficiency of the servo writer, a sample may be taken just from the beginning of each pancake. The servo writer may write a statistically significant length of the medium at a reduced linear tape speed and laser pulse rate. This approach keeps the writing rate substantially within the optical detection system's sampling bandwidth. The time to sample a given area is determined by the CCD bandwidth, the number of marks to be sampled, the number of measurements to be made on each mark, and the process bandwidth of the controlling computer. Typically, the CCD bandwidth will be the limiting factor. After the power setting is determined at the lower speed, the servo writer may be set to normal operating speeds (linear velocity and laser pulse repetition rate).

The calibration procedure may be repeated for each pancake. The power feedback control employed by the servo writer of the invention permits the marks on tapes from different pancake batches to have substantially similar quality parameters. For example, assuming that the thicknesses of the track layers of the different tapes are within approximately 12% of each other, the servo writer of the invention may achieve resulting quality parameters, such as depth and diameter, within tolerances of approximately 15% and 1%, respectively.

The servo writer could employ imaging feedback not just during a discrete calibration mode, but in real time during the writing of each mark along the tape 106. In that case, the servo writer may employ Active Pixel Sensors (“APS”) for high speed imaging. This is, however, not as computationally efficient as using the discrete calibration mode and unnecessary for a tape having statistically similar physical characteristics within a batch.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather interpreted according to the scope of the claims.

1. A system for calibrating servo marks formed in a tape medium, the system comprising:
an emitter for directing a beam of radiation toward the medium to form at least one mark;
a detector for detecting at least one image of the at least one mark; and
a controller for determining at least one parameter of the at least one mark, and for adjusting power of the radiation beam based on the at least one parameter.

2. The system of claim 1, wherein the emitter is a laser.

3. The method of claim 1, wherein the detector includes at least one CCD array.

4. The system of claim 1, wherein the at least one parameter includes diameter and depth.

5. The system of claim 1, wherein the medium includes at least two layers, and the emitter forms the at least one mark in a layer opposite a magnetic surface of the medium.

6. The system of claim 1, wherein each image detected by the detector represents a plurality of marks along a servo track in a longitudinal direction.

7. The system of claim 1, wherein each image detected by the detector represents an area of marks from multiple servo tracks in both longitudinal and lateral directions.

8. The system of claim 1, wherein
the detector provides to the controller the at least one image of the at least one mark, and
the controller compares the at least one image of the at least one mark to a reference image, and determines the at least one parameter based on the comparison.

9. The system of claim 8, wherein each image provided by the detector represents a plurality of marks along a servo track in a longitudinal direction.

10. The system of claim 8, wherein each image provided by the detector represents an area of marks from multiple servo tracks in both longitudinal and lateral directions.

11. The system of claim 1, wherein
the detector includes two imaging elements that provide images to the controller, and
the controller stereoscopically determines the at least one parameter based on the images from the imaging elements.

12. A method for calibrating servo marks formed in a tape medium, the method comprising:
directing a beam of radiation toward the medium to form at least one mark;
detecting at least one image of the at least one mark;
determining at least one parameter of the at least one mark; and
adjusting power of the radiation beam based on the at least one parameter.

13. The method of claim 12, wherein a laser directs the beam of radiation.

14. The method of claim 12, wherein a CCD detects the at least one image.

15. The method of claim 12, wherein the at least one parameter includes diameter and depth.

16. The method of claim 12, wherein the medium includes at least two layers, and the at least one mark is formed in a layer opposite a magnetic surface of the medium.

17. The method of claim 12, wherein each detected image represents a plurality of marks along a servo track in a longitudinal direction.

18. The method of claim 12, wherein each detected image represents an area of marks from multiple servo tracks in both longitudinal and lateral directions.

19. The method of claim 12, further comprising:
providing to the controller the at least one image of the at least one mark;
comparing the at least one image of the at least one mark to a reference image; and
determining the at least one parameter based on the comparison.

20. The method of claim 19, wherein each image represents a plurality of marks along a servo track in a longitudinal direction.

21. The method of claim 19, wherein each image represents an area of marks from multiple servo tracks in both longitudinal and lateral directions.

22. The method of claim 12, wherein the at least one image includes two images, the method further comprising stereoscopically determining the at least one parameter based on the images.

23. A tape medium comprising:
a plurality of layers, including a magnetic layer for storing information; and
a plurality of servo marks in at least one layer disposed in a longitudinal direction on the medium,
wherein the servo marks have a spatial density of at least 14,000 marks per meter in the longitudinal direction.

24. The magnetic tape medium of claim 23, wherein the plurality of servo marks is also disposed in a lateral direction on the medium, the servo marks having a spatial density of at least 14,000 marks per meter in the lateral direction.

25. The medium of claim 23, wherein each servo mark is within approximately 2-12 microns in diameter and 20-200 nm in depth.

26. A plurality of magnetic tape media, comprising:
a first tape medium including a first plurality of servo marks; and
a second tape medium including a second plurality of servo marks, each tape medium having a plurality of layers including a track layer,
wherein the first and second pluralities of servo marks are written in the track layer by the same servo writer, the track layer of the first tape medium differs in thickness from the track layer of the second tape medium, and the first plurality of servo marks has substantially the same diameter as the second plurality of servo marks.

27. The plurality of tape media of claim 26, wherein the thickness of the track layer of the first tape medium is within 12% of the thickness of the track layer of the second tape medium, and the diameter of each mark of the first plurality of servo marks is within 1.0% of the diameter of each mark of the second plurality of servo marks.

28. The plurality of tape media of claim 26, wherein the first plurality of servo marks also has substantially the same depth as the second plurality of servo marks.

29. The plurality of tape media of claim 26, wherein the thickness of the track layer of the first tape is within 12% of the thickness of the track layer of the second tape, and the depth of each mark of the first plurality of servo marks is within 15.0% of the depth of each mark of the second plurality of servo marks.

30. The plurality of tape media of claim 26, wherein the first and second tapes are produced from different tape batches.

31. The plurality of tape media of claim 26, wherein the servo marks are disposed in at least the track layer in a longitudinal direction on the tape medium, and the servo marks have a spatial density of at least 14,000 servo marks per meter in the longitudinal direction.

32. The magnetic tape medium of claim 31, wherein the servo marks are also disposed in a lateral direction on the tape medium, and the servo marks have a spatial density of at least 14,000 servo marks per meter in the lateral direction.

33. The medium of claim 1, wherein each mark is within approximately 2-12 microns in diameter and 20-200 nm in depth
